(19) United States
(12) Patent Application Publication
(10) Pub. No.: US 2015/0169980 A1
(43) Pub. Date: Jun. 18, 2015

(54) OBJECT RECOGNITION DEVICE

(71) Applicant: HONDA MOTOR CO., LTD., MINATO-KU, TOKYO (JP)

(72) Inventors: Kodai Matsuda, Saitama (JP); Izumi Takatsudo, Saitama (JP); Hiroshi Hattori, Saitama (JP)

(21) Appl. No.: 14/408,437

(22) PCT Filed: Mar. 15, 2013
(86) PCT No.: PCT/JP2013/057363

§ 371 Date: Dec. 16, 2014

(30) Foreign Application Priority Data
Jun. 26, 2012 (JP) 2012-143562

(51) Int. Cl. G06K 9/46; G06K 9/00

(52) U.S. Cl. CPC G06K 9/4661; G06K 9/4647; G06K 9/00805

(57) ABSTRACT

An object recognition device including a binarization processing unit 32 which classifies pixels, which are obtained by excluding pixels having luminance values equal to or lower than a predetermined value Yex indicating pixels on which the sky is projected in an image captured by an infrared camera 11R, into low-luminance pixels and high-luminance pixels according to a binarization-use second threshold Yth2 (>Yex); and an object image extraction unit 35 which extracts an image portion of an object from an image region composed of the low-luminance pixels.

### TECHNICAL FIELD

The present invention relates to a device for recognizing an object to be monitored such as a living body by using an image captured by an infrared camera.

### BACKGROUND ART

There has conventionally been known a device for recognizing an object to be monitored which is present in a capturing region of an infrared camera mounted on a vehicle by acquiring a captured image around the vehicle by using the infrared camera and then extracting an image portion of the object to be monitored on the basis of a binary image generated by binarizing the captured image.

For example, Patent Literature 1 describes a technique of recognizing a living body such as a person as an object to be monitored which is present in a capturing region of an infrared camera by extracting an image of the living body from a high-luminance region (a region composed of pixels having high-luminance values) in the binary image described above.

### CITATION LIST

### Patent Literature

Patent Literature 1: Japanese Patent Application Laid-Open No. 2003-284057

### SUMMARY OF INVENTION

### Technical Problem

In the case where a living body such as a person as an object to be monitored is present in a capturing region of an infrared camera mounted on a vehicle, the living body generally has relatively higher temperatures than subjects (a road surface, a wall surface of a structure, or the like) in the surroundings (background) of the living body in a normal environment.

In this case, the image of the living body in the image captured by the infrared camera has relatively high luminance in comparison with the background image. Therefore, in the normal environment, it is possible to extract an image of the living body from the high-luminance region of the image captured by the infrared camera.

In the case where the ambient temperature is high, however, the temperature of the living body is sometimes relatively lower than the temperatures of the background subjects. In such a case, the image of the living body in the image captured by the infrared camera has relatively low luminance in comparison with the background image.

Therefore, in order to enable the recognition of the living body present in the capturing region of the infrared camera in a situation that the temperature of the living body is possibly relatively lower than the temperatures of the background subjects, the present inventors are considering that the image of the living body is extracted from a low-luminance region composed of pixels having relatively low luminance in the image captured by the infrared camera.

In this case, however, the present inventors have found that it is sometimes difficult to extract the image of the living body from the low-luminance region of the image captured by the infrared camera as a result of various experiments and inspections performed by the present inventors.

Specifically, the image captured by the infrared camera mounted on the vehicle usually includes an image region on which the sky is projected. Since the sky projected on the image region has a low temperature irrespective of the ambient temperature or the like, the image region of the sky is a low-luminance image region.

Therefore, if the luminance threshold for binarizing the captured image is inappropriate, the image of the living body having a relatively lower temperature than the temperature of the background might be excluded from the low-luminance region in some cases. Further, in this case, there is a problem that the image portion of the living body having the relatively low temperature cannot be appropriately extracted from the low-luminance region.

The present invention has been made in view of the above background. Therefore, it is an object of the present invention to provide an object recognition device capable of appropriately recognizing an object such as a living body having a relatively lower temperature than the temperature of the background on the basis of the image captured by an infrared camera.

### Solution to Problem

In order to achieve the above object, according to an aspect of the present invention, there is provided an object recognition device having a function of recognizing an object which is present in a capturing region of an infrared camera and has a relatively lower temperature than the temperature of background based on an image captured by the infrared camera, the object recognition device comprising: a binarization processing element which is configured to classify pixels obtained by excluding pixels having luminance values equal to or lower than a predetermined value indicating pixels on which the sky is projected in the captured image into low-luminance pixels having luminance values equal to or lower than a binarization-use threshold set to a luminance value higher than the predetermined value and high-luminance pixels having luminance values higher than the binarization-use threshold; and an object image extraction element which is configured to extract an image portion of the object from an image region composed of the low-luminance pixels in the captured image (First aspect of the invention).

According to the first aspect of the invention, the binarization processing element classifies pixels obtained by excluding pixels having luminance values equal to or lower than a predetermined value indicating pixels on which the sky is projected in the captured image into low-luminance pixels having luminance values equal to or lower than a binarization-use threshold and high-luminance pixels having luminance values higher than the binarization-use threshold.

In this case, the binarization-use threshold is set to a luminance value higher than the predetermined value. Therefore, in the case where there exists an object having a relatively lower temperature than the temperature of the background in the capturing region of the infrared camera, the pixels of the image portion of the object (an image of the whole or a part of the object) in the captured image are able to be low-luminance pixels among the low-luminance pixels and the high-luminance pixels described above.

Therefore, in the case where there exists an object having a relatively lower temperature than the temperature of the background in the capturing region of the infrared camera, the object image extraction element is able to extract the image portion of the object from the image region composed of the low-luminance pixels (hereinafter, sometimes referred to as “low-luminance image region”). Thus, this enables the recognition that the object is present in the capturing region of the infrared camera.

Therefore, according to the first aspect of the invention, it is possible to appropriately recognize an object such as a living body having a relatively lower temperature than the temperature of the background from the image captured by the infrared camera.

In this respect, the luminance values of the pixels in the image region of the sky projected on the image captured by the infrared camera are normally lower than the luminance values of other image regions (image regions on which some object is projected), while having some variation according to the sky state such as the presence or absence of clouds. Moreover, in the case an area of the image region of the sky projected on the captured image is large, variation in the luminance of the pixels of the sky image region occurs more easily than the case the area of the sky image region is small.

Accordingly, in the first aspect of the invention, it is preferable to further comprise an exclusion-use luminance value setting element configured to set the predetermined value so that the predetermined value is varied according to an area of the image region in which the sky is projected or a luminance representative value of the image region in the captured image (Second aspect of the invention).

Note that the aforementioned luminance representative value means a representative value of the luminance of the image region on which the sky is projected. As the representative value, it is possible to use the average value, the maximum value, or the like of the luminance of the upper part (a part on which the sky is estimated to be projected) of the image captured by the infrared camera, for example.

According to the second aspect of the invention, the predetermined value can be appropriately set so that the predetermined value reflects the variation in the luminance of the pixels of the image region on which the sky is prOjected.

For example, the exclusion-use luminance value setting element is configured to set the predetermined value to a greater value as the area of the image region on which the sky is projected is larger or as the luminance representative value of the image region is greater (Third aspect of the invention). This prevents the pixels obtained by excluding pixels having luminance values equal to or lower than the predetermined value from including the pixels on which the sky is projected as much as possible.

Therefore, it is possible to prevent the image portion not corresponding to the object from being extracted as the image portion of the object by performing the processing of the object image extraction element, namely, the processing of extracting the image portion of the object from the low-luminance image region. Consequently, the reliability of the processing of the object image extraction element can be increased.

In the first to third aspects of the invention, preferably the binarization processing element includes a binarization-use threshold setting element which is configured to set the binarization-use threshold based on a histogram representing a relation between the luminance values and the number of pixels in the image region composed of pixels obtained by excluding the pixels having luminance values equal to or lower than the predetermined value in the captured image (Fourth aspect of the invention).

According to the fourth aspect of the invention, in the case where an object having a relatively lower temperature than the temperature of the background is present in the capturing region of the infrared camera, the binarization-use threshold can be set appropriately so that the pixels of the image portion of the object in the captured image are low-luminance pixels among the low-luminance pixels and the high-luminance pixels described above with high certainty.

### BRIEF DESCRIPTION OF DRAWINGS

FIG. 1 is a diagram illustrating a vehicle equipped with an object recognition device according to one embodiment of the present invention.

FIG. 2 is a block diagram illustrating the configuration of the object recognition device illustrated in FIG. 1

FIG. 3 is a flowchart illustrating the processing of the object recognition device illustrated in FIG. 1

FIG. 4 is a diagram illustrating an example of a histogram used in the processes of steps 2, 6, and 7 in FIG. 3.

FIG. 5A is a diagram illustrating an example of a captured image and FIG. 5B is a diagram illustrating an example of a binary image in which the captured image in FIG. 5A is binarized.

### DESCRIPTION OF EMBODIMENTS

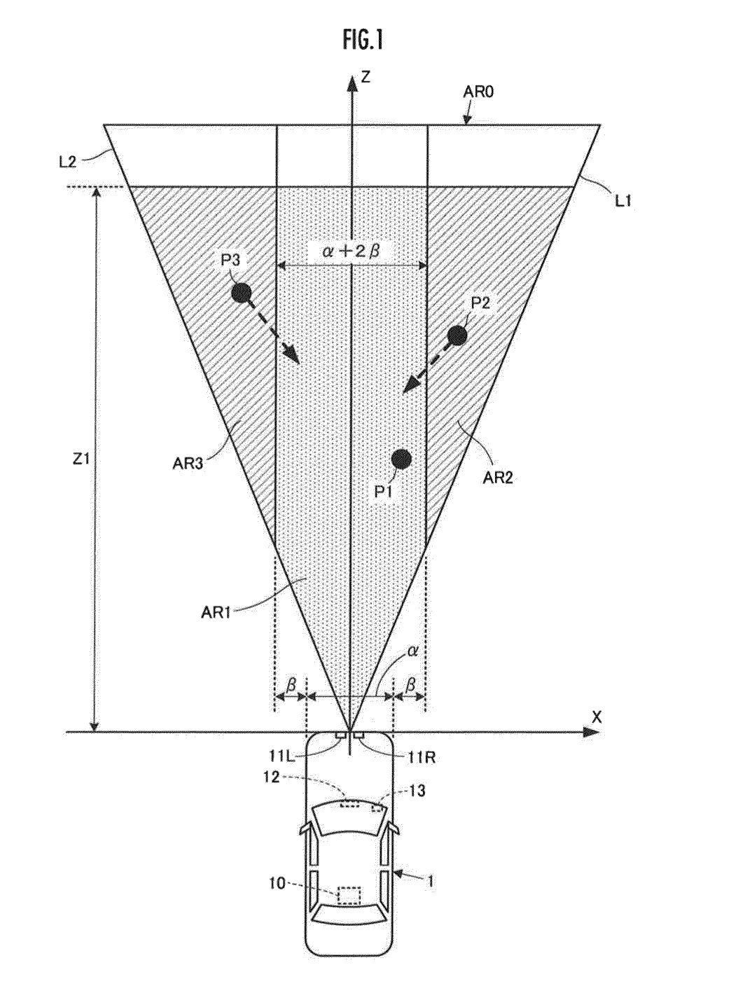

One embodiment of an object recognition device according to the present invention will be described with reference to FIGS. 1 to 5. Referring to FIG. 1, an object recognition device 10 according to this embodiment is mounted on a vehicle 1. In addition to the object recognition device 10, the vehicle 1 is equipped with two cameras 11L and 11R constituting a stereo camera for capturing images of a predetermined monitoring region AR0 (a view angle region between straight lines L1 and L2 in FIG. 1) around the vehicle 1, a display unit 12 by which the driver of the vehicle 1 visibly displays display information such as an image captured by one of the cameras 11L and 11R (for example, by the camera 11R), and a speaker 13 which outputs acoustic information (voice, alarm sound, or the like) of which the driver of the vehicle 1 is notified.

The display unit 12 includes a liquid crystal display installed in the vehicle compartment in front of the driver's seat of the vehicle 1, a head-up display which displays a projected image by projecting a video image on the windshield of the vehicle 1, or the like. In addition, the display unit 12 may be one capable of appropriately displaying navigation information (a map, etc.), audio information, and the like in addition to the image captured by the camera 11R.

Both of the cameras 11L and 11R are infrared cameras having sensitivity in the infrared wavelength region. Further, the cameras 11L and 11R each output a video signal indicating the luminance of each of the pixels constituting an image captured by each camera 11L or 11R. The monitoring region AR0 (hereinafter, sometimes referred to as “capturing region AR0”) captured by the camera 11L or 11R is a region on the front side of the vehicle 1 in this embodiment. In order to capture the monitoring region AR0, the cameras 11L and 11R are mounted in the front section of the vehicle 1.

In this case, the cameras 11L and 11R are arranged in parallel in the vehicle width direction of the vehicle 1 in the positions substantially symmetrical with respect to the central axis (the Z axis in FIG. 1) in the vehicle width direction (the X-axis direction of FIG. 1) of the vehicle 1. Moreover, the cameras 11L and 11R are attached to the front section of the vehicle 1 so that the optical axes of the cameras 11L and 11R are parallel to each other and the heights from the road surface are equal.

Each of the cameras 11L and 11R has characteristics described below in the luminance of the captured image defined by the video signals of the camera 11L or 11R with respect to the distribution state of the temperatures of the entire subject in the capturing region AR0 in the captured image. The characteristics are such that the luminance of the image of an arbitrary object in the capturing region AR0 (the luminance of the image of the vicinity of the projection region of the object) is not the luminance corresponding to the degree of the temperature itself, but is the luminance corresponding to a relative temperature difference between the object and the background thereof (the subjects [the wall surface of a building, a road surface, or the like] present behind the object, viewed from the camera 11L or 11R) (hereinafter, the characteristics are referred to as “AC characteristics”).

In the AC characteristics, as the temperature of the arbitrary object in the capturing region AR0 is higher than the temperature of the background of the object, the luminance of the image of the object increases. Moreover, as the temperature of the object is lower than the temperature of the background of the object, the luminance of the image of the object decreases.

The image captured by the camera 11L or 11R having the above AC characteristics is, in other words, a captured image with a luminance change highlighted in an image portion which includes a portion having a relatively significant temperature change (a spatial temperature change) in the entire subject within the capturing region AR0. Furthermore, in the captured image, the luminance of the image portion which includes a portion having a uniform temperature (a portion whose subsections have temperatures substantially equal to each other) is substantially the same luminance irrespective of the degree of the temperature (absolute temperature).

The cameras 11L and 11R of this embodiment have the AC characteristics as described above.

Additionally, the respective cameras 11L and 11R themselves do not need to have AC characteristics. Specifically, each camera 11L or 11R may have characteristics that the luminance of each pixel defined by a video signal output from the camera is the luminance corresponding to the degree of the temperature of the subject projected on the pixels (the higher the temperature is, the higher the luminance is). In that case, a captured image having the aforementioned AC characteristics can be obtained by applying video filtering to the captured image defined by the video signals of the camera 11L or 11R.

In the following description, one of the cameras 11L and 11R constituting the stereo camera such as, for example, the right-hand camera 11R is sometimes referred to as “reference camera 11R.”

The object recognition device 10 is an electronic circuit unit including a CPU, a memory, an interface circuit, and the like, which are not illustrated. The object recognition device 10 performs predetermined control processing by executing an installed program by using the CPU.

Specifically, the object recognition device 10 recognizes predetermined types of objects to be monitored which is present in the capturing region AR0 on the basis of the image captured by the camera 11L or 11R. The object is a living body such as a pedestrian (person) or a wild animal.

The object recognition device 10 tracks the position of the object (the relative position with respect to the vehicle 1) while detecting a distance between the vehicle 1 and the object present ahead of the vehicle 1 for each predetermined control processing cycle. Furthermore, in the case where the object is a living body determined to be likely to come in contact with the vehicle 1, the object recognition device 10 performs attention calling processing in which an alarm is displayed on the display unit 12 and an alarm sound (or alarm voice) is output from the speaker 13 in order to call attention of the driver of the vehicle 1 to the object (living body).

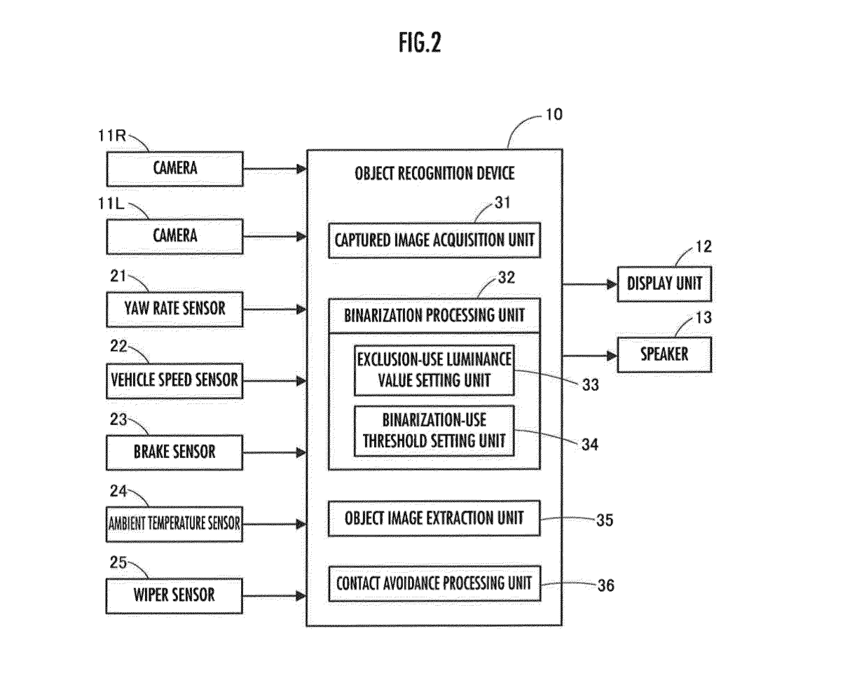

The above object recognition device 10 will be described in more detail with reference to FIG. 2. The object recognition device 10 receives inputs of video signals from the camera 11L or 11R and inputs of detection signals from various sensors mounted on the vehicle 1.

In this embodiment, the object recognition device 10 receives inputs of detection signals from a yaw rate sensor 21 which detects the yaw rate of the vehicle 1, a vehicle speed sensor 22 which detects the vehicle speed of the vehicle 1, a brake sensor 23 which detects a driver's brake operation (the depression of a brake pedal), an ambient temperature sensor 24 which detects an ambient temperature, a wiper sensor 25 which detects the operating state of a wiper (not illustrated) of the windshield of the vehicle 1 (or an operation command signal of the wiper).

Moreover, the object recognition device 10 is connected to the display unit 12 and the speaker 13. The object recognition device 10 then controls the display on the display unit 12 and the acoustic output from the speaker 13.

Additionally, as functions implemented by executing installed programs by using the CPU (functions implemented by the software configuration) or main functions implemented by the hardware configuration (an input-output circuit, an arithmetic circuit, and the like), the object recognition device 10 includes a captured image acquisition unit 31 which acquires a captured image (a captured image having the aforementioned AC characteristics) of the camera 11L or 11R, a binarization processing unit 32 which performs binarization processing for binarizing the captured image, an object image extraction unit 35 which extracts an image portion of an object likely to be a living body (an object to be a candidate for a living body) by using a binary image obtained by the binarization processing, and a contact avoidance processing unit 36 which determines whether the object whose image portion is extracted by the object image extraction unit 35 is a living body likely to come in contact with the vehicle 1 and performs the attention calling processing in the case where a result of the determination is affirmative.

In this case, the binarization processing unit 32 and the object image extraction unit 35 correspond to a binarization processing element and an object image extraction element of the present invention, respectively. In addition, the binarization processing unit 32 includes functions as an exclusion-use luminance value setting unit 33 corresponding to an exclusion-use luminance value setting element of the present invention and a binarization-use threshold setting unit 34 corresponding to a binarization-use threshold setting element of the present invention.

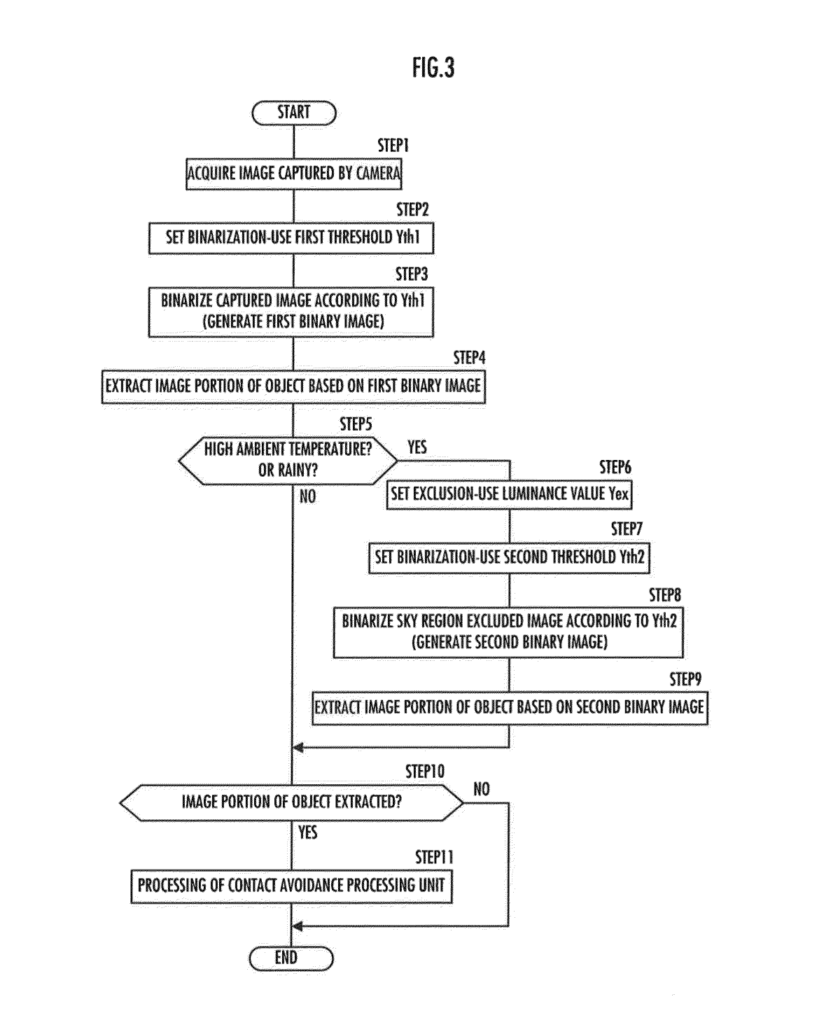

The following describes the processing of the object recognition device 10 with reference to a flowchart of FIG. 3. The object recognition device 10 recognizes an object present in the monitoring region (capturing region) AR0 existing ahead of the vehicle 1 by performing processing illustrated in the flowchart of FIG. 3 for each predetermined control cycle.

The object recognition device 10 performs the processing of step 1 by using the captured image acquisition unit 31, first. In this processing, the captured image acquisition unit 31 acquires an image captured by the camera 11L or 11R.

More specifically, the captured image acquisition unit 31 causes the camera 11L or 11R to capture images of the capturing region AR0. Then, the captured image acquisition unit 31 acquires a captured image (the captured image having the AC characteristics described above) where the luminance value of each pixel is represented by a digital value for each camera 11L or 11R by A-D converting the video signals output from the camera 11L or 11R according to the capturing. Thereafter, the captured image acquisition unit 31 stores and holds the acquired image captured by the camera 11L or 11R in the image memory (not illustrated).

Note that the captured image acquisition unit 31 causes the image memory to store and hold a plurality of captured images for a period of time until a predetermined time, including the latest captured image.

Additionally, in the case where the camera 11L or 11R does not have the AC characteristics, the captured image acquisition unit 31 may acquire a captured image having the AC characteristics by applying video filtering processing to the captured image defined by the video signals of the infrared cameras.

Subsequently, the object recognition device 10 performs the processes of steps 2 to 4 by using the binarization processing unit 32 and the object image extraction unit 35.

Steps 2 and 3 are the processes of the binarization processing unit 32. In step 2, the binarization processing unit 32 performs the processing of the binarization-use threshold setting unit 34. In this processing, the binarization-use threshold setting unit 34 sets a binarization-use first threshold Yth1 for binarizing the image captured by the reference camera 11R. In this case, the binarization-use threshold setting unit 34 sets the binarization-use first threshold Yth1 on the basis of a histogram which represents the relationship between the luminance values of the respective pixels of the image captured by the reference camera 11R and the number of pixels (frequency) (hereinafter, the histogram is referred to as “first luminance histogram”).

The binarization-use first threshold Yth1 is set so that the luminance of the image portion of a living body in the image captured by the camera 11L or 11R is higher than the binarization-use first threshold Yth1, where the living body is a person or the like as an object to be monitored and present in the capturing region AR0 of the camera 11L or 11R, in the case where the temperature of the living body is higher than the temperatures of the subjects on the background of the living body.

In this embodiment, the binarization-use first threshold Yth1 is set in a so-called P-tile method on the basis of the first luminance histogram. Specifically, in the first luminance histogram, the binarization-use first threshold Yth1 is set so that the total number of pixels equal to or higher than the binarization-use first threshold Yth1 equals the number of pixels of a predetermined percentage of the sum total number of pixels of the captured image.

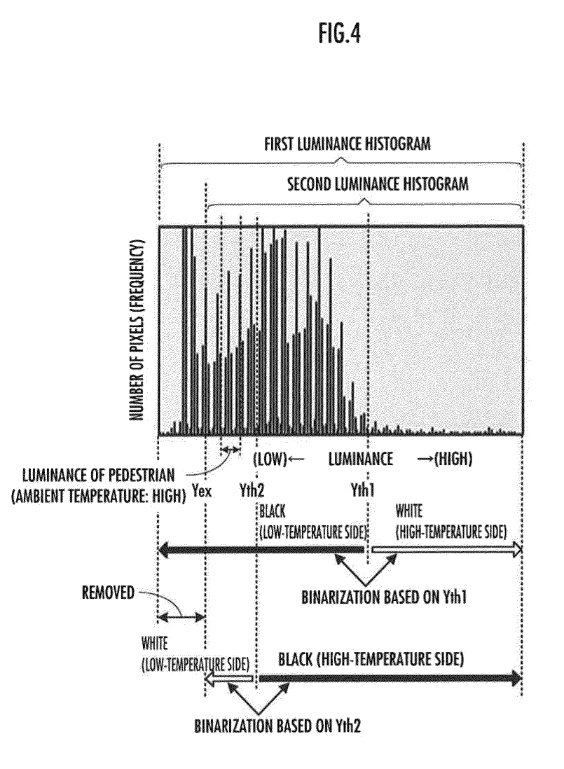

For example, in the case where the first luminance histogram is as illustrated in FIG. 4, Yth1 in FIG. 4 is set as a binarization-use first threshold.

Subsequently, in step 3, the binarization processing unit 32 generates a first binary image by binarizing the image captured by the reference camera 11R according to the binarization-use first threshold Yth1 set as described above.

Specifically, the binarization processing unit 32 binarizes the captured image by classifying the pixels of the image captured by the reference camera 11R into two types: pixels having high luminance values equal to or higher than Yth1 and pixels having low luminance values lower than Yth1. Then, the binarization processing unit 32 defines the pixels having the high luminance values to be white pixels and the pixels having the low luminance value to be black pixels, thereby generating the first binary image.

In the case where the first binary image is generated as such and it is found that a living body such as a person as an object to be monitored is present in the capturing region AR0 of the camera 11L or 11R and the temperature of the living body is higher than the temperatures of the background subjects (in the normal case), the image portion of the living body appears as a local white region in the first binary image.

In addition, the first binary image may be generated by defining the pixels having the high luminance values equal to or higher than Yth1 to be black pixels and defining the pixels having the low luminance values lower than Yth1 to be white pixels.

The next step 4 is a process of the object image extraction unit 35. In this step 4, the object image extraction unit 35 extracts the image portion of an object as a candidate for a living body from the white region (an image region composed of white pixels [pixels having high luminance values equal to or higher than Yth1]) in the first binary image.

In step 4, the image portion of the object to be extracted is an image portion where, for example, the longitudinal and lateral widths, a ratio of these widths, the height from the road surface, a luminance average value, the luminance variance, and the like are within a preset range (within a range set on the assumption that the object is a living body such as a person or a wild animal).

Accordingly, in the case where a living body such as a person as an object to be monitored which is present in the capturing region AR0 of the camera 11L or 11R exists and where the temperature of the living body is higher than the temperatures of the background subjects (in the normal case), the image portion of the living body is extracted in step 4.

Additionally, in the case where the first binary image is generated by defining the pixels having high luminance values equal to or higher than Yth1 to be black pixels and defining the pixels having low luminance values lower than Yth1 to be white pixels, the image portion of the object as a candidate for a living body may be extracted from the black region in the first binary image.

Subsequently, the object recognition device 10 performs determination process of step 5. In step 5, the object recognition device 10 determines the current environmental condition. The determination process is performed to determine whether or not one of the condition that the current ambient temperature is a high temperature equal to or higher than a predetermined temperature and the condition that the current weather is rainy is satisfied.

In this case, the object recognition device 10 determines whether or not the ambient temperature is a high temperature equal to or higher than the predetermined temperature on the basis of a detection value of the ambient temperature detected by the ambient temperature sensor 24.

Moreover, the object recognition device 10 determines whether or not the current weather is rainy on the basis of the operating condition of the wiper indicated by the output of the wiper sensor 25 (or an operation command signal of the wiper). More specifically, the object recognition device 10 determines that the current weather is rainy if the wiper is in operation and determines that the current weather is not rainy if the wiper is not in operation.

Note that a raindrop sensor may be used to detect whether or not the current weather is rainy. Alternatively, weather information may be received through communication to recognize whether or not the current weather is rainy.

Incidentally, the temperature of the living body such as a person (pedestrian) is higher than the temperature of the road surface or other surrounding objects around the living body in a normal environment (in an environment where the ambient temperature is not so high). Therefore, in the case where a living body is included in the captured image (captured image having the AC characteristics) of the camera 11L or 11R which is an infrared camera, the luminance of the image of the living body is generally higher than the luminance of the images of the subjects (the road surface, the wall surface of a building, or the like) on the background of the living body.

On the other hand, in the case where the ambient temperature is high or the current weather is rainy or the like, the temperature of the living body such as a person (pedestrian) is sometimes lower than the temperature of the surrounding objects. In that case, the luminance of the image portion of the living body in the image captured by the camera 11L or 11R is lower than the luminance of the images of the subjects (the road surface, the wall surface of a building, or the like) on the background of the living body.

Furthermore, in this case, the image portion of the living body is a black image (an image having low luminance values) in the first binary image. Therefore, in the above step 4, the image portion of the living body cannot be extracted.

Therefore, if the determination result of the above step 5 is affirmative, in other words, if it is supposed that the temperature of the living body present in the capturing region AR0 of the camera 11L or 11R is relatively lower than the temperatures of the surrounding objects (the background subjects), the object recognition device 10 further performs the processes of steps 6 to 9 by using the binarization processing unit 32 and the object image extraction unit 35 to extract the image portion of the object as a candidate for the living body.

Steps 6 to 8 are processes of the binarization processing unit 32. In step 6, the binarization processing unit 32 performs the processing of the exclusion-use luminance value setting unit 33. In this processing, the exclusion-use luminance value setting unit 33 sets an exclusion-use luminance value Yex which is used to exclude pixels on which the sky is projected from the targets of binarization on the basis of the image captured by the reference camera 11R. The exclusion-use luminance value Yex corresponds to a “predetermined value” of the present invention.

Here, normally a video image of the sky is projected on the image captured by the camera 11L or 11R. Additionally, the temperature of the sky is generally lower than other subjects (the road surface, a structure, a living body, and the like). Therefore, the luminance values of the pixels of the whole or most of the image region on which the sky is projected in the image captured by the camera 11L or 11R are lower than certain luminance values.

The exclusion-use luminance value Yex is basically a luminance value set so that the luminance values of the pixels on which the sky is projected in the image captured by the camera 11L or 11R are equal to or lower than Yex.

There is, however, some variation in the luminance values of the pixels in the image region on which the sky is projected according to the presence or absence of clouds or according to the influence of the area or the like of the image region of the sky. For example, if the video image of clouds is projected on the image region of the sky, the luminance values of the pixels are higher than those in the case where the video image of clouds is not projected.

Moreover, if the area of the image region of the sky is large, variation easily increases in the luminance values of the pixels of the image region of the sky in comparison with the case where the area of the image region of the sky is small.

Therefore, in this embodiment, the exclusion-use luminance value setting unit 33 sets the exclusion-use luminance value Yex variably. Concretely, the average value or the maximum value of the luminance in the position near the upper end (the image region on which the sky is estimated to be projected) in the image captured by the reference camera 11R is calculated as a luminance representative value in the position concerned.

Moreover, in the region on the upper side of the image captured by the reference camera 11R, the number of pixels having luminance values equal to or lower than a preset given value is calculated as the number of pixels of the sky area which schematically represents the area of the sky in the captured image. Alternatively, in the region on the upper side of the image captured by the reference camera 11R, the boundary between the sky image region and the image region of other subjects may be detected by an edge extraction approach or the like to calculate the number of pixels of the region enclosed by the boundary as the number of pixels of the sky area.

Then, the exclusion-use luminance value Yex is set on the basis of a preset given map or arithmetic expression from the aforementioned luminance representative value and the number of pixels of the sky area. In this case, the exclusion-use luminance value Yex is set so that the exclusion-use luminance value Yex has a greater value as the luminance representative value is greater. Moreover, the exclusion-use luminance value Yex is set so that the exclusion-use luminance value Yex has a greater value as the number of pixels of the sky area is greater (as the area of the region on which the sky is projected in the captured image is larger).

Subsequently, in step 7, the binarization processing unit 32 performs the processing of the binarization-use threshold setting unit 34. In this processing, the binarization-use threshold setting unit 34 sets a binarization-use second threshold Yth2 for binarizing an image obtained by excluding the pixels having luminance values equal to or lower than the exclusion-use luminance value Yex (pixels on which the sky is considered to be projected) (hereinafter, the image is referred to as “sky region excluded image”) from the image captured by the reference camera 11R. The sky region excluded image is, in other words, an image composed of pixels having luminance values higher than the exclusion-use luminance value Yex in the image captured by the reference camera 11R. The binarization-use second threshold Yth2 corresponds to a binarization-use threshold of the present invention.

In this case, the binarization-use threshold setting unit 34 sets the binarization-use second threshold Yth2 on the basis of a histogram (hereinafter, referred to as “second luminance histogram”) representing a relation between the luminance values of the pixels of the aforementioned sky region excluded image and the number of pixels (frequency) thereof. The second luminance histogram is, as illustrated in FIG. 4, a portion obtained by excluding a portion where the luminance values are equal to or lower than Yex from the first luminance histogram.

The binarization-use second threshold Yth2 is a threshold set so that, in the case where the temperature of the living body such as a person as an object to be monitored, which is present in the capturing region AR0 of the camera 11L or 11R, is lower than the temperatures of the subjects on the background of the living body, the luminance of the image portion of the living body in the image captured by the camera 11L or 11R is lower than the binarization-use second threshold Yth2.

In this embodiment, the binarization-use second threshold Yth2 is set in the P-tile method similarly to the binarization-use first threshold Yth1. In this case, however, the binarization-use second threshold Yth2 is set on the basis of the second luminance histogram, instead of the first luminance histogram. Specifically, the binarization-use second threshold Yth2 is set so that the total number of pixels equal to or lower than the binarization-use second threshold Yth2 equals the number of pixels of a predetermined percentage of the sum total number of pixels of the captured image in the second luminance histogram. In this case, the binarization-use second threshold Yth2 equals a luminance value higher than the exclusion-use luminance value Yex.

For example, if the second luminance histogram is as illustrated in FIG. 4, the binarization-use second threshold Yth2 (>Yex) in FIG. 4 is set as a binarization-use second threshold.

Subsequently, in step 8, the binarization processing unit 32 generates a second binary image by binarizing the sky region excluded image according to the binarization-use second threshold Yth2 as described above.

Concretely, the sky region excluded image is binarized by classifying the pixels of the sky region excluded image into two types: pixels having low luminance values equal to or lower than Yth2 and pixels having high luminance values higher than Yth2. Then, contrary to the case of the first binary image, the pixels having low luminance values are defined as white pixels and the pixels having high luminance values are defined as black pixels, by which the second binary image is generated.

The generation of the second binary image as described above causes the image portion of the living body to be a local white region in the second binary image in the case where there exists a living body such as a person as an object to be monitored in the capturing region AR0 of the camera 11L or 11R and the temperature of the living body is lower than the temperatures of the background subjects in a situation where the determination result of step 5 is affirmative.

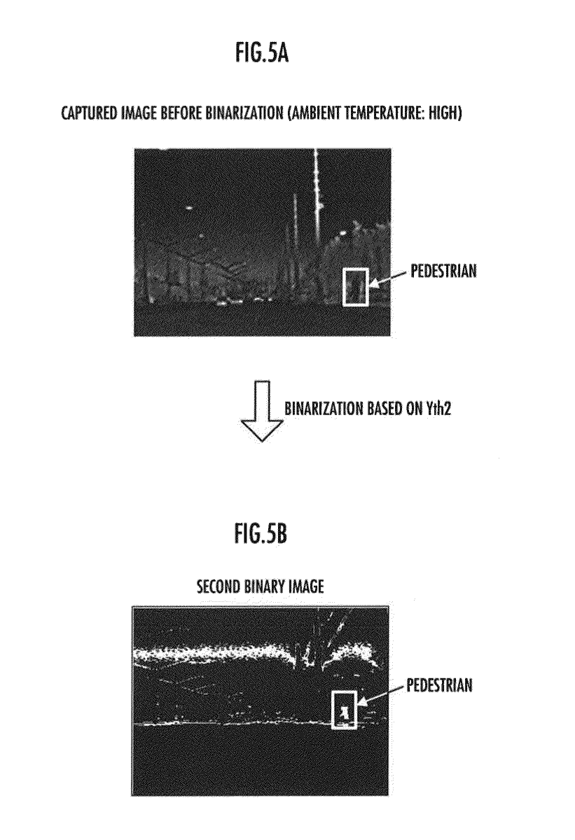

For example, in a situation where the ambient temperature is higher than a predetermined temperature, an image captured by the reference camera 11R (or the camera 11L) as illustrated in FIG. 5A is obtained. In this case, the image portion of the person is low in luminance as illustrated in FIG. 5A due to the temperature of the person (pedestrian) present in the capturing region AR0 being lower than the temperatures of the background subjects.

The first luminance histogram and the second luminance histogram in the captured image are those illustrated in FIG. 4. Furthermore, in this case, the sky region excluded image is binarized according to the binarization-use second threshold Yth2 illustrated in FIG. 4 in step 8, by which the second binary image is generated as illustrated in FIG. 5B. In the second binary image, the image portion of the person (pedestrian) illustrated in FIG. 5A is obtained as a local white region.

Note that, however, in the second binary image in FIG. 5B, the pixels having luminance values equal to or lower than the exclusion-use luminance value Yex (the pixels on which the sky is considered to be projected), in other words, the pixels of portions other than the sky region excluded image in the captured image are forcibly set to black pixels.

Supplementarily, in the binarization of the sky region excluded image in step 8, the second binary image may be generated with black pixels as the pixels having low luminance values equal to or lower than Yth2 and white pixels as the pixels having high luminance values higher than Yth2.

Alternatively, the second binary image (a binary image with one of the two types of pixels as white pixels and the other type of pixels as black pixels) may be generated by generating a reverse image obtained by reversing the high-low of the luminance values of the respective pixels of the sky region excluded image before the binarization and classifying the pixels of the reverse image into two types: pixels having luminance values equal to or higher than the threshold where the binarization-use second threshold Yth2 is reversed (hereinafter, referred to as “reverse threshold”) and pixels having luminance values lower than the reverse threshold.

The reverse image is, more specifically, an image where the luminance value of each pixel coincides with a value obtained by subtracting the luminance value Y in the sky region excluded image from the maximum luminance value (for example, in the case of 8-bit gray scale, a luminance value of 255) (=maximum luminance value−Y). Similarly, the aforementioned reverse threshold is a value obtained by subtracting the binarization-use second threshold Yth2 from the maximum luminance value (=maximum luminance value−Yth2).

Subsequently, in step 9, the object recognition device 10 performs the processing of the object image extraction unit 35. In step 9, the object image extraction unit 35 extracts the image portion of the object as a candidate for a living body from the white region (an image region composed of white pixels [pixels having low luminance values equal to or lower than Yth2]) in the second binary image.

The extraction processing of step 9 is performed in the same manner as the aforementioned extraction processing of step 4. In this case, the image portion of the living body is the image portion of a white region in the second binary image and therefore the image portion of the object can be extracted by the same program processing as in step 4.

In the case where the second binary image is generated by defining the pixels having low luminance values equal to or lower than Yth2 as black pixels and the pixels having luminance values higher than Yth2 as white pixels, the image portion of an object as a candidate for a living body may be extracted from the black region in the second binary image.

The processes of steps 2 to 4 and 6 to 9 described hereinabove are details of the processing of the binarization processing unit 32 and the processing of the object image extraction unit 35.

The object recognition device 10 subsequently performs a determination process of step 10. In this determination process, it is determined whether or not the object as the candidate for the living body is successfully extracted by steps 2 to 9 described above.

If the determination result is negative, the processing of the current control processing cycle of the object recognition device 10 ends.

Meanwhile, if the determination result of step 10 is affirmative, the object recognition device 10 subsequently performs the process of step 11 by using the contact avoidance processing unit 36.

In this process, the contact avoidance processing unit 36 calculates the real space position of the object, identifies whether the object is a living body to be monitored, and determines whether the object is likely to come in contact with the vehicle 1 by performing the same processing as one described in, for example, Patent Literature 1 with respect to the object (the candidate for the living body) extracted by the object image extraction unit 35.

The outline of the process will be described hereinafter. The contact avoidance processing unit 36 estimates a distance between the object and the vehicle 1 (own vehicle) in a stereo distance measurement method based on the parallax of the image portion of the object in each of the cameras 11L and 11R. Furthermore, the contact avoidance processing unit 36 estimates the real space position (the relative position to the own vehicle 1) on the basis of the estimated value of the distance and the position of the image portion of the object in the image captured by the reference camera 11R.

The contact avoidance processing unit 36 determines that the object (for example, the object indicated by P1 in FIG. 1) is likely to come in contact with the own vehicle 1 in the future in the case where the real space position of the object is within a contact determination region AR1 (the stippled region in FIG. 1) which is set as illustrated in FIG. 1 in the capturing region AR0.

The contact determination region AR1 is set as a region where the distance from the own vehicle 1 is equal to or less than the distance value Z1 determined according to the vehicle speed (detection value) of the own vehicle 1 (for example, a value obtained by multiplying the vehicle speed by a predetermined proportional constant) in the capturing region AR0 and where the width of the region AR1 is obtained by adding predetermined margin width β to each of the sides of the vehicle width α of the own vehicle 1 in the front forward direction of the own vehicle 1 (=α+2β).

Moreover, the contact avoidance processing unit 36 determines that the object (for example, the object indicated by P2 or P3 in FIG. 1) is likely to come in contact with the own vehicle 1 in the future also in the case where the real space position of the object is within an entry determination region AR2 or AR3 (the lane region in FIG. 1) set as illustrated in FIG. 1 outside the right and left of the contact determination region AR1 in the capturing region AR0 and where the direction of the movement vector of the object is a direction of entering the contact determination region AR 1.

The entry determination region AR2 or AR3 is set as a region obtained by excluding the contact determination region AR1 from the region where the distance from the own vehicle 1 is equal to or less than the distance value Z1 in the capturing region AR0.

Moreover, the direction of the movement vector of the object is identified, for example, from the time series of the estimated value of the real space position up to just before the predetermined time of the object.

The contact determination region AR1 and the entry determination regions AR2 and AR3 are regions each having a range also in the height direction of the own vehicle 1 (regions each having a height equal to or less than a predetermined height which is greater than the vehicle height of the own vehicle 1). Furthermore, an object present in a position higher than the predetermined height is determined to be unlikely to come in contact with the own vehicle 1 in the future.

Moreover, the contact avoidance processing unit 36 identifies (determines) whether or not the object determined to be likely to come in contact with the own vehicle 1 in the future is a living body such as a person.

In this case, it is identified whether or not the object is a person on the basis of the features such as the shape, size, or luminance distribution of the image portion of the object in the image captured by the reference camera 11R (more specifically, the object whose image portion is extracted by the object image extraction unit 35 and which is determined to be likely to come in contact with the own vehicle 1 in the future by the contact avoidance processing unit 36) (for example, by an approach described in the aforementioned Patent Literature 1).

In the case where the object is determined to be other than a person, it may be further determined whether the object is a wild animal such as a quadruped.

Moreover, various approaches have already been known in addition to the approach described in Patent Literature 1 as the method of determining whether or not the object is a living body such as a person, and any one of the approaches may be used.

Furthermore, the contact avoidance processing unit 36 performs the attention calling processing with respect to an object which is likely to come in contact with the own vehicle 1 and is identified to be a living body such as a person.

Concretely, the contact avoidance processing unit 36 controls the display unit 12 to display the image captured by the reference camera 11R on the display unit 12 while highlighting the image of the object (a living body likely to come in contact with the own vehicle 1) in the captured image. For example, the contact avoidance processing unit 36 causes the display unit 12 to display the image of the object in the captured image displayed on the display unit 12 so as to be enclosed by a frame in a predetermined color or enclosed by a blinking frame to highlight the image of the object.

Moreover, the contact avoidance processing unit 36 controls the speaker 13 to output an alarm sound (or voice) indicating that the living body likely to come in contact with the own vehicle 1 is present in the capturing region (monitoring region) AR0.

The control of the display by the display unit 12 and the control of the speaker 13 give a visual alarm and an audible alarm related to the living body likely to come in contact with the own vehicle 1 to the driver. Consequently, the driver's attention to the living body is invoked. This causes the driver to perform driving operation (brake operation, etc.) enabling appropriate avoidance of contact between the living body and the own vehicle 1, thereby enabling avoidance of the contact between the living body and the own vehicle 1.

Even if there is a living body determined to be likely to come in contact with the own vehicle 1 in the capturing region AR0, the aforementioned attention calling processing may be omitted in the case where it is detected by the output of the brake sensor 23 that the driver has already performed the brake operation of the vehicle 1.

Alternatively, even in a situation where the brake operation of the vehicle 1 has already been performed, whether or not to perform the attention calling processing may be selected according to, for example, the depression amount of the brake pedal or the deceleration degree of the vehicle 1.

Supplementarily, although the driver's attention has been invoked by the visual notification with the display unit 12 and the audible notification with the speaker 13 in order to avoid contact between the living body and the own vehicle 1 in this embodiment, it may be performed with only one notification.

Alternatively, the driver's attention may be invoked by performing sensory notification such as vibrating the driver's seat, instead of one or both of the visual notification and the audible notification.

Moreover, in the case where the braking device of the vehicle 1 is configured to be able to adjust its braking force on the basis of a braking force according to the operation of the brake pedal by hydraulic control or the like, the braking force of the braking device may be automatically increased in addition to invoking the driver's attention.

According to the preferred embodiments described hereinabove, in a situation where the determination result of the above step 5 is affirmative, in other words, in a situation where the temperature of the living body such as a person is likely to be lower than the temperature of the surrounding objects (the background subjects) around the living body in the case where the living body is present in the capturing region AR0 of the camera 11L or 11R, the image portion of the object (an object whose temperature is relatively lower than the temperatures of the background subjects) as a candidate for the living body is extracted from the second binary image by the processes of steps 6 to 9.

In this case, the binarization for generating the second binary image is performed by using the binarization-use second threshold Yth2 higher in the luminance value than Yex for the sky region excluded image which is obtained by excluding the image region (an image region composed of pixels having luminance values equal to or lower than the exclusion-use luminance value Yex), on which the sky is considered to be projected, from the image captured by the reference camera 11R.

Therefore, in the case where the object (an object likely to be a living body) whose temperature is relatively lower than the background subjects is present in the capturing region AR0 of the camera 11L or 11R, the luminance value of the image portion of the object in the image captured by the reference camera 11R is able to be set to a luminance value equal to or lower than the binarization-use second threshold Yth2.

Accordingly, the object as a candidate for the living body whose temperature is relatively lower than the temperatures of the background subjects is able to be appropriately extracted from the white region (a region composed of pixels having low luminance values equal to or lower than Yth2) in the second binary image.

Moreover, the exclusion-use luminance value Yex is variably set so as to reflect the occurrence of variation in the luminance values of the sky image region, which is caused by the presence or absence of clouds in the sky, the area of the sky image region in the captured image, or the like. Therefore, the exclusion-use luminance value Yex can be set so as to prevent the pixels of the image region of the actual sky in the captured image from being included in the sky region excluded image as much as possible (in other words, so that the luminance values of all or most of pixels in the image region of the actual sky are equal to or lower than Yex).

Therefore, the object as a candidate for the living body whose temperature is relatively lower than the background subjects is able to be extracted with higher certainty from the white region (a region composed of pixels having low luminance values equal to or lower than Yth2) in the second binary image generated by binarizing the sky region excluded image according to the binarization-use second threshold Yth2.

The following describes some of the variations of the embodiments described hereinabove.

In the above embodiments, the processes of steps 6 to 9 have been performed only in the case where the determination result of step 5 in FIG. 3 is affirmative. The processes of steps 6 to 9, however, may be normally performed with the determination process of step 5 omitted.

Moreover, the processes of steps 6 to 9 may be performed before the processes of steps 2 to 4 or may be performed in parallel with the processes of steps 2 to 4 by using a plurality of CPUs or by time-division processing.

Furthermore, in the determination process of step 5, only whether or not the ambient temperature is high may be determined.

In addition, the system with two cameras 11L and 11R constituting the stereo camera has been exemplified in the above embodiments. The system, however, may be equipped with only one camera (an infrared camera). In this case, the distance between the object such as a living body in the image captured by the camera and the own vehicle 1 may be measured by another distance measuring device such as a radar device. Alternatively, the distance between the object and the own vehicle 1 may be estimated from the time rate of change or the like of the size of the image portion of the object in the time series of the image captured by the camera.

Moreover, in the above embodiments, the image portion of the object whose temperature is relatively higher than the background subjects is extracted through the processes of steps 2 to 4. In the case where it is previously known that the temperature of the object to be extracted is lower than the temperatures of the subjects on the background of the object, however, the image portion of the object (an object relatively low in temperature) may be extracted through the processes of steps 6 to 9 with the processes of steps 2 to 4 omitted. In this case, the object may be a physical body other than a living body.

Furthermore, the exclusion-use luminance value Yex may be a constant value in a situation where it is known that the luminance of the sky image region is maintained substantially at constant luminance. Alternatively, the exclusion-use luminance value Yex may be varied appropriately according to a parameter other than the luminance representative value or area of the sky image region.

Moreover, in the above embodiments, the binary images (the first binary image and the second binary image) are generated before the image portion of the object is extracted. Without generating the binary images, however, it is also possible to extract the image portion of the object such as a living body or the like from the region composed of pixels having luminance values equal to or higher than the binarization-use first threshold Yth1 or the region composed of pixels having luminance values equal to or lower than the binarization-use second threshold Yth2 in the image captured by the camera 11L or 11R.

Furthermore, in the above embodiments, the description has been made by giving an example of a system in which the object recognition device 10 and the cameras 11L and 11R are mounted on the vehicle 1. The present invention, however, is also applicable to a case where a camera (an infrared camera) for acquiring a captured image is installed beside a road, at an entrance of facilities, or other given places.

1. An object recognition device having a function of recognizing an object which is present in a capturing region of an infrared camera and has a relatively lower temperature than a temperature of background based on an image captured by the infrared camera, the object recognition device comprising:
a binarization processing element which is configured to classify pixels obtained by excluding pixels having luminance values equal to or lower than a predetermined value indicating pixels on which the sky is projected in the captured image into low-luminance pixels having luminance values equal to or lower than a binarization-use threshold set to a luminance value higher than the predetermined value and high-luminance pixels having luminance values higher than the binarization-use threshold; and
an object image extraction element which is configured to extract an image portion of the object from an image region composed of the low-luminance pixels in the captured image.

2. The object recognition device according to claim 1, further comprising an exclusion-use luminance value setting element configured to set the predetermined value so that the predetermined value is varied according to an area of the image region on which the sky is projected or a luminance representative value of the image region in the captured image.

3. The object recognition device according to claim 2, wherein the exclusion-use luminance value setting element is configured to set the predetermined value to a greater value as the area of the image region on which the sky is projected is larger or as the luminance representative value of the image region is greater.

4. The object recognition device according to claim 1, wherein the binarization processing element includes a binarization-use threshold setting element which is configured to set the binarization-use threshold based on a histogram representing a relation between luminance values and number of pixels in an image region composed of pixels obtained by excluding the pixels having luminance values equal to or lower than the predetermined value in the captured image.
